(19) United States
(12) Patent Application Publication
(10) Pub. No.: US 2026/0284671 A1
(43) Pub. Date: Sep. 24, 2026

(54) Method and Apparatus For Material Processing

(71) Applicants: Michael Gay, Norman, OK (US); Colton Gay, Norman, OK (US)

(72) Inventors: Michael Gay, Norman, OK (US); Colton Gay, Norman, OK (US)

(21) Appl. No.: 19/577,350

(22) Filed: Mar. 24, 2026

Related U.S. Application Data
(60) Provisional application No. 63/776,845, filed on Mar. 24, 2025.

(51) Int. Cl. B02C 13/09

(52) U.S. Cl. CPC B02C 13/09

(57) ABSTRACT

An apparatus for material processing unit is disclosed. The unit comprises a housing, a motor, a target, and a rotor assembly rotated by the motor and having features for placement of material engaging cutting tools. The housing comprises a housing shell having two ends and an end plate having at least one inset pocket to accept a housing component. One or more inset pockets are configured to be slidably engaged by a housing component.

### CROSS REFERENCE TO RELATED APPLICATION

This application claims the benefit of prior-filed U.S. provisional application No. 63/776,845 (filed on Mar. 24, 2025), which is incorporated by reference herein.

### BACKGROUND

There are a variety of applications where processing consolidated material can be used to support construction and maintenance operations such as site preparation, road maintenance and road construction. In some cases, the consolidated material can be slab rock, large boulders, rocks embedded in the ground, or loose rock that needs to be made smaller. Often times the material is fully removed and processed offsite or gathered and processed into a smaller size with a localized plant on location. A more efficient manner of processing the material would be to do it in place and redistribute as desired to create the required grade. Other types of materials can require similar processing, such as wood and other organic materials through a mulching process.

In general, a material processing unit is constructed of a housing component and a rotor component disposed within the housing. This arrangement can be created as an attachment to a carrier unit or integrated into a standalone piece of equipment. The rotor component is typically powered by a hydraulic or electric motor. The primary power source can be from an existing circuit on the carrier unit or a standalone power source mounted to the carrier unit. The rotor typically has a plurality of cutting tools placed in a pattern around the rotor core and affixed to the rotor core with cutting tool holders. Often the cutting tool holder is placed on a stand to elevate the tip of the cutting tool from the outer surface of the rotor core.

Due to the size of the equipment, many of the components such as the housing and rotor are welded components which present a variety of manufacturing challenges in terms of accurate component placement, structural integrity, and warpage. It is common to use fixturing to hold items in place while welding or tacking. However, fixturing is typically expensive, difficult to use, and relies on excessive measurements to place the fixturing on the assembly. Heat imparted by the welding process can cause warpage of the assembly even when substantial effort is taken to support and constrain the components. These issues can detrimentally affect the equipment by requiring large overall tolerances resulting in loose fits and unnecessary loading due to component misalignment. The misplacement of components can also lead to interchangeability issues and poorly matched replacement components. Traditional fabrication techniques place components improperly with other components, further exacerbating the placement and alignment issues encountered in the fabrication process. Housing elements are often worn due to the harsh environment of crushed materials and high speed rotation.

Rotor construction is a particular concern due to rotation. Imbalance can cause substantial loads to be disseminated throughout the material processing unit, which then causes excessive wear or failure in both the material processing equipment and the carrier unit. The imbalance can be manifested as vibration within the equipment that can also translate to the operator, thereby causing fatigue or injury. Degradation of rotor balance cascades into increased wear and component failure, often producing loads far in excess of what is mathematically predicted and designed.

It is common for material processing equipment to operate at a rotational speed ranging from 100 to 600 rpm. Experimentation has shown that increasing the rotational speed enhances the size reduction of the material processing. However, the same increase in speed amplifies the impact of any imbalance and misalignment in the equipment. The inventors have devised methods to address the associated fabrication inconsistencies and arrangements that use component interactions to promote squareness and rigidity of the finished product. The benefits of these developments improve equipment performance and reliability in known operating ranges, and facilitate expanded operating range by increasing the rotational speed. Together, these reduce the size of the processed material and increase the overall efficiency of the material processing.

### SUMMARY

In one aspect, a material processing unit is disclosed herein. The apparatus comprises a housing, a motor, a target, and rotor assembly rotated by the motor. The rotor assembly can have features for placement of material engaging cutting tools. The housing comprises a housing shell having two ends and an end plate having at least one inset pocket to accept a component of the housing.

In another aspect, one or more of the inset pockets are configured to be slidably engaged by a housing component. In another aspect, the target is oriented at an angle between 30 degrees and 60 degrees of a horizontal plane. In another aspect, the material processing unit further comprises a processing chamber having at least 80% of the tangents to the rotor assembly that enter the processing chamber intersects the target with at least 85% of a tangent vector normal to the target. The unit can also further comprise a secondary target, wherein the target and the housing shell form a first processing chamber such that at least 80% of the tangents to the rotor assembly entering the first processing chamber intersect the secondary target with at least 85% of a tangent vector normal to the secondary target. In other aspects, the unit can further comprise a second end plate having an inset pocket to accept a second housing shell end, and can further comprise a second end plate having a second slidably engageable pocket to receive and retain a housing component. In another aspect, the unit can further comprise a skeletonized overlay plate affixed to and reinforcing the housing shell, covering less than 50% of the housing shell at a location adjacent material impacts radial to the rotor assembly.

In another aspect, a housing for a material processing unit is disclosed. The housing comprises a target, a housing shell having two ends, an end plate secured to one of the housing shell ends, the housing is adapted to connect to a rotor assembly rotated by a motor and having material cutting tools, and the end plate is connected to the target between 0 inches and 3 inches above a ground plane.

In another aspect, the housing has one or more inset pockets configured to be slidably engaged by a housing component. The target can also be oriented within 15 degrees of normal to a tangent of the rotor assembly that intersects the target. The housing can further comprise a processing chamber having at least 80% of the tangents to the rotor assembly that enter the processing chamber intersect the target with at least 85% of a tangent vector normal to the target. In yet another aspect, the housing further comprises a secondary target, wherein the target and the housing shell form a first processing chamber such that at least 80% of the tangents to the rotor assembly entering the first processing chamber intersect the secondary target with at least 85% of a tangent vector normal to the secondary target. The housing can also further comprise a second end plate having an inset pocket to accept a second housing shell end, a second end plate having a second slidably engageable pocket to receive and retain a housing component, or a skeletonized overlay plate affixed to and reinforcing the housing shell and covering less than 50% of the housing shell at a location adjacent to material impacts radial to the rotor assembly.

In another aspect, a material processing unit is disclosed. The unit comprises a housing, a motor, a target, a rotor assembly rotated by the motor and having features for placement of material engaging cutting tools. The housing comprises a housing shell having two ends, an end plate having an inset pocket to accept one of the housing shell ends, a rotor mount attachable to the end plate and the rotor, having centering lugs to attach the rotor mount to the end plate, wherein the end plate further comprises an inset groove to receive and retain the target, and wherein the target is between 0 inches and 3 inches above a ground plane.

In another aspect, the target is oriented at an angle of 45 degrees, plus or minus 15 degrees, of a horizontal plane. The unit can further comprise a processing chamber having at least 80% of the tangents to the rotor assembly that enter the processing chamber intersect the target with at least 85% of a tangent vector normal to the target. The unit can also include a secondary target, wherein the target and the housing shell form a first processing chamber such that at least 80% of the tangents to the rotor assembly entering the first processing chamber intersect the secondary target with at least 85% of a tangent vector normal to the secondary target. Other aspects can include a second end plate having a inset pocket to accept a housing component or a second end plate having a second inset groove to receive and retain a housing component.

In another aspect, a material processing unit is disclosed. The unit comprises a housing comprising a housing shell and an end plate attached to the housing shell, a motor, a rotor assembly adapted to be rotated by the motor and having features for placement of material engaging cutting tools, and a rotor centering mechanism comprising a centering plate having a shaft attachable to the rotor and centering lug holes, and centering lugs adapted to fit the lug holes. The unit can also have the end plate adapted to receive a target.

In another aspect, a material processing unit is disclosed. The unit comprises a housing, a motor, a target, a rotor assembly rotated by the motor and having features for placement of material engaging cutting tools, and the housing comprises a housing shell having two ends. The unit further comprises an end plate having an inset pocket to accept one of the housing shell ends and the end plate further comprises an inset pocket to receive and retain the target between 0 and 3 inches above a ground plane. The unit can also have a second inset pocket that receives and retains a housing component.

In another aspect, a material processing unit is disclosed. The unit comprises a housing, a motor, a target, a rotor assembly rotated by the motor and having features for placement of material engaging cutting tools, and a processing chamber having at least 80% of the tangents to the rotor assembly that enter the processing chamber intersect the target with at least 85% of a tangent vector normal to the target. The unit can also further comprise a secondary target, wherein the target and the housing shell form a first processing chamber such that at least 80% of the tangents to the rotor assembly entering the first processing chamber intersect the secondary target with at least 85% of a tangent vector normal to the secondary target.

### BRIEF DESCRIPTION OF THE DRAWINGS

The drawings included with this application illustrate certain aspects of the embodiments described herein. However, the drawings should not be viewed as exclusive embodiments. The subject matter disclosed is capable of considerable modifications, alterations, combinations, and equivalents in form and function, as will occur to those skilled in the art with the benefit of this disclosure.

FIG. 1 is a perspective view of one embodiment of the material processing unit disclosed herein.

FIG. 2 is an elevation view of one embodiment of an end plate of the material processing unit.

FIG. 3 is a perspective view of one embodiment of an end plate of the material processing unit.

FIG. 4 is a perspective view of one embodiment of the material processing unit herein.

FIG. 5 is a perspective view of one embodiment of the material processing unit herein.

FIGS. 6a, 6b and 6c are cross-section views for multiple housing layouts for a material processing unit.

FIG. 7 is a cross-section view for a housing layout for a material processing unit.

FIG. 8 is a cross-section view for a housing including a bidirectional member as positioned in a cut in a level orientation.

FIG. 9 illustrates a cross-section view for a housing including a bidirectional member as positioned in a cut while in a rolled orientation.

FIG. 10 illustrates a centering bolt arrangement for a support shaft of a material processing unit.

FIG. 11 illustrates a centering nut arrangement for a rotor mount of a material processing unit.

### DETAILED DESCRIPTION

The present disclosure may be understood more readily by reference to this detailed description. Numerous specific details are set forth in order to provide a thorough understanding of the various embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein.

In one aspect, this disclosure provides a material processing unit. In another aspect, this disclosure provides a housing for a material processing unit.

In one embodiment, the material processing unit disclosed herein comprises:
a. a housing;
b. a motor;
c. a target;
d. a rotor assembly rotated by the motor and having features for placement of material engaging cutting tools;
e. wherein the housing comprises a housing shell having two ends; and an end plate having at least one inset pocket to accept a component of the housing.

In other embodiments, the unit can have one or more inset pockets to be engaged by a housing component. A target can be oriented at an angle between 30 degrees and 60 degrees of a horizontal plane. A processing unit and a housing can have a processing chamber. A housing can include a skeletonized overlay plate. A target can be located within the housing. For example, a target can be between 0 and 3 inches above a ground plane.

In other embodiments, a unit can have a processing chamber having at least 80% of the tangents to the rotor assembly that enter the processing chamber intersect the target with at least 85% of a tangent vector normal to the target.

As used herein and in the appended claims, a “target” means an element in a material processing unit in which a material such as rock, concrete or others strikes to create an impact. A “target” can be made of a hardened material. For example, a “target” can be made from AR400 steel, a multitude of hardened metals, or other materials. A unit can have multiple targets.

As used herein and in the appended claims, a “rotor assembly” is a rotating body that can include cutting tools on its surface. For example, a rotor assembly can be a cylindrical body that rotates, thereby rapidly moving cutting tools toward materials for processing. For example, the rotor assembly can cause the cutting tools to strike materials.

As used herein and in the appended claims, an “inset pocket” means a machined slot or detent in a material. An inset pocket preferably does not fully penetrate the material in which it is machined. For example, two pieces of metal can be connected by an inset pocket and welded to strengthen a connection.

As used herein and in the appended claims, a “housing component” means a part incorporated or used in a housing. For example, a housing component can be a housing shell or an end plate. For example, a housing component can be a target.

As used herein and in the appended claims, a “ground plane” means a plane that is at the level of the ground on which the unit operates. For example, the unit can ride on the ground plane during processing.

As used herein and in the appended claims, a “horizontal plane” means a plane that is generally horizontal to the ground. For example, a horizontal plane is generally horizontal to a ground plane.

As used herein and in the appended claims, a “tangent vector” means the components of a tangent. For example, a rotor assembly that has a generally round cross section that has many tangents. For example, each tangent can be broken down into its vector component.

As used herein and in the appended claims, a “secondary target” means a target that occurs after a first target. For example, a processing unit can have multiple targets, including a secondary target and a tertiary target.

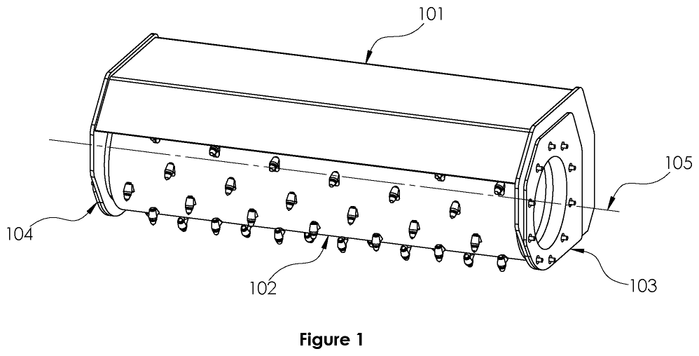

Referring now to FIG. 1, shown therein is an example material processing unit with housing assembly 101, rotor assembly 102 and rotor mounts 103 and 104. The rotational axis 105 is defined as the axis running through rotor assembly 102 and is constrained by rotor mounts 103 and 104 and further constrained by housing assembly 101.

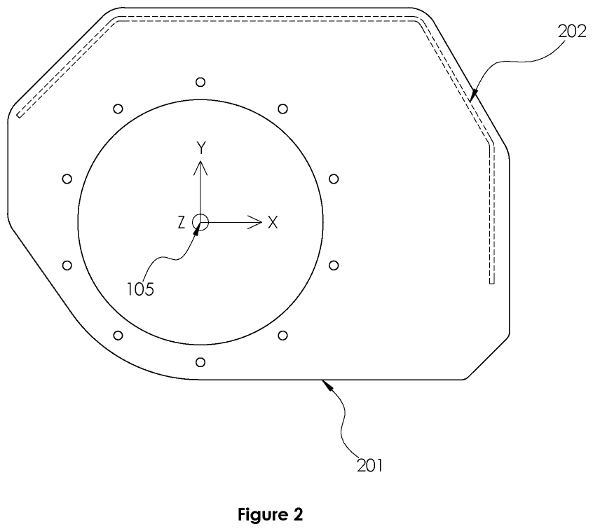

In the material processing unit the rotational axis of the components are preferably collocated, such as the rotation axis if the motor, rotor and axial rotation around rotational axis 105. However, in some embodiments such collocation is not required. Manufacturing variances and design tolerances can lead to misalignment. Referring now to FIG. 2, one aspect of the alignment is the XY positioning of housing end plate 201 relative to housing shell 202. It is understood that although only one housing end plate 201 is shown, there is preferably a corresponding end plate that opposes the shown end plate. Another aspect of the alignment is how housing end plate 201 is aligned to the XY plane. For example, perfect planar alignment would have housing end plate 201 parallel to the XY plane, which is normal to the perfect rotational axis 105. Misalignment could cause housing end plate 201 to be canted from the XY plane and/or variation of the XY coordinates aligning the components to rotational axis 105. Slots and tabs are known in the art as a way of locating components during fabrication and are commonly cut at the time the plate parts are cut using a plasma or laser cutter. These slots and tabs are sized to account for the cut tolerance and material thickness variations as well as distortion of the material during the cutting process.

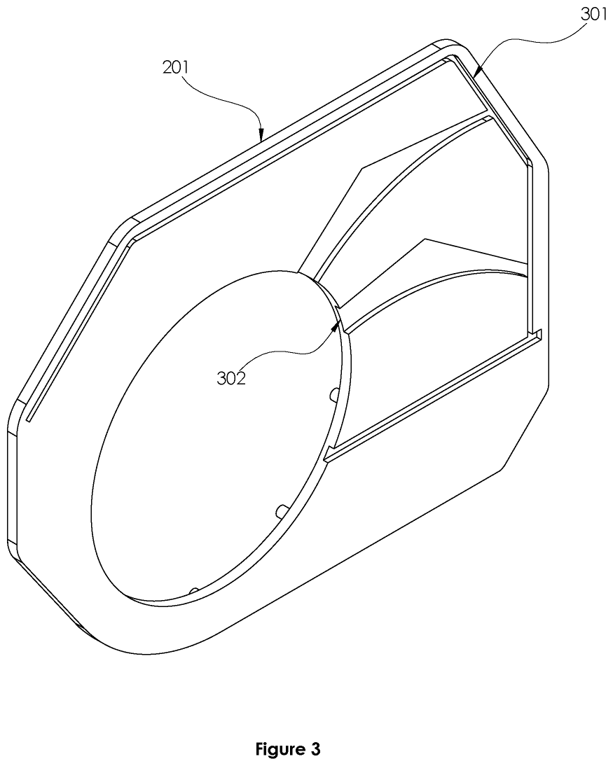

Referring to FIG. 3, shown therein is a housing end plate with an example machine pocket 301 that receives housing shell 202. This approach prevents distortion of end plates 103, 104 and provides a much more consistent and defined shoulder for engagement. Some cutting operations such as oxy-fuel cause a local metallurgical change of the metal, which can detrimentally affect the performance of the overall component and welds placed at the cut locations. Although machining is not restricted to a milling process in which an end mill is used to remove material, processes that scrape material, such as metal, the component does not undergo a localized metallurgical change. Also, a slot or inset cut by a plasma or laser cutter approximately the size of the slot cannot be easily adjusted after it is cut. This leads to a situation in which mistakes cause waste and typically cannot be undone. Unlike the plasma and laser cutters, the machining process allows the operator to cut a small pocket and later cut a finishing pass to create the desired dimension. This results in a more precise and repeatable feature.

Another benefit of the machined pocket is that the free end of the non-pocketed component is supported during and after the welding process and can support loads whereas a free end is unable to support stresses created during the welding process. This support and ability to carry stresses on that edge significantly reduces warpage due to the welding process, which promotes proper alignment. This is particularly evident and important in the alignment of housing end plate 201 relative to the XY plane. Proper implementation of the pocket placement will also provide a high level of precision in the XY placement of housing end plate 201. Since the pocket does not extend through the component, the pocket can be substantially longer than a slot used with the traditional slot and tab approach which would significantly weaken the component. Additionally, there is no need to weld on the opposite side of the tabbed component to seal the joint from environmental exposure. Such additional weld imparts additional residual stress that can cause warpage.

Housing assembly 101 is constructed of housing end plates 201, housing shell 202 and additional components not shown in FIG. 2. Those components not shown are included for material processing and rigidity of the structure. It is common to add these components after housing end plates 201 are welded to housing shell 202 because they can obstruct fully welding the housing end plates 201. In the event they do not obstruct the welding there are challenges of locating and holding those components in the proper place while also holding housing end plates 201 together with housing shell 202. The machined pocket concept can be extended to create a machined feature where one or more sides are removed as shown at removed side 302. The removal of one or more sides creates a slidable interaction between the two components that offers precision placement and interlocked support for the components while still being able to insert the component after housing end plates have been affixed to housing shell 202. A traditional slot and tab approach for these components requiring full penetration of the component thickness would significantly reduce structural rigidity because the open pocket perimeter is unable to transfer stress and the part would be susceptible to significant warpage. It is understood that housing end plate features such as machine pocket 301 would be mirrored to the opposing housing end plate not shown.

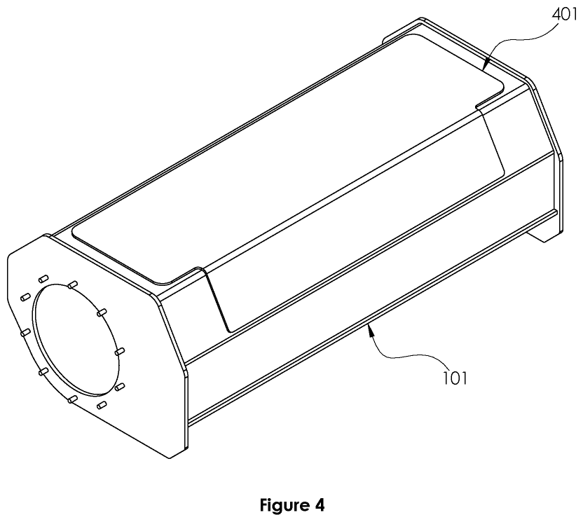

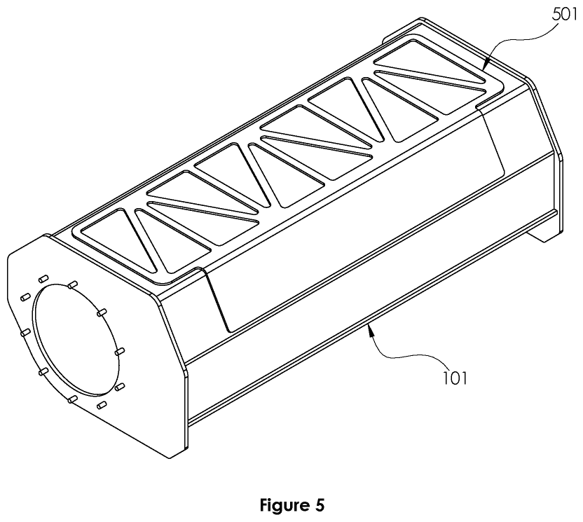

One embodiment of the material processing unit utilizes a tool strike against consolidated material to break it down, which requires the material to be held in place. If the material is embedded in the ground, the ground provides the force to hold the material in place; however, if the material is free, it can be trapped against a target in the material processing unit for the strike. Another embodiment of the material processing unit utilizes an impingement target that the material is thrown against when the material is free and uses the impact force to break the material down. Regardless of the embodiment examined, rigidity of the target is important for effective material processing as flexing of the target or structure supporting the target absorbs energy which is not imparted to the material processing event, thus reducing the effectiveness of the material processing. One method of increasing the stiffness of the housing assembly is to increase the thickness of the housing shell. However, the weight of the material processing unit can grow to a point where the carrier unit is unable to successfully or safely lift and manipulate the material processing unit. Referring to FIG. 4 shows housing assembly 101 with overlay plate 401. The overlay plate is affixed to the housing and locally increases the stiffness of the housing and consequently increases the rigidity of the housing structure without increasing the weight as much as the same thickness increase applied to the entire housing shell. The thickness and physical location of the overlay plate can be optimized to balance the various design considerations such as overall weight, overall stiffness, localized stiffness and weight distribution. It is possible to construct the overlay plate with weight reduction features to further tailor the stiffness and weight properties of the housing assembly. In order to realize the maximum gain in stiffness overlay plate 401 should interact with the housing in a 3-dimensional manner, such as spanning two bent surfaces or matching a rolled surface. Referring now to FIG. 5, a skeletonized overlay plate 501 is shown as an example of an overlay plate with weight reduction features to further tailor the stiffness location and weight associated with the feature.

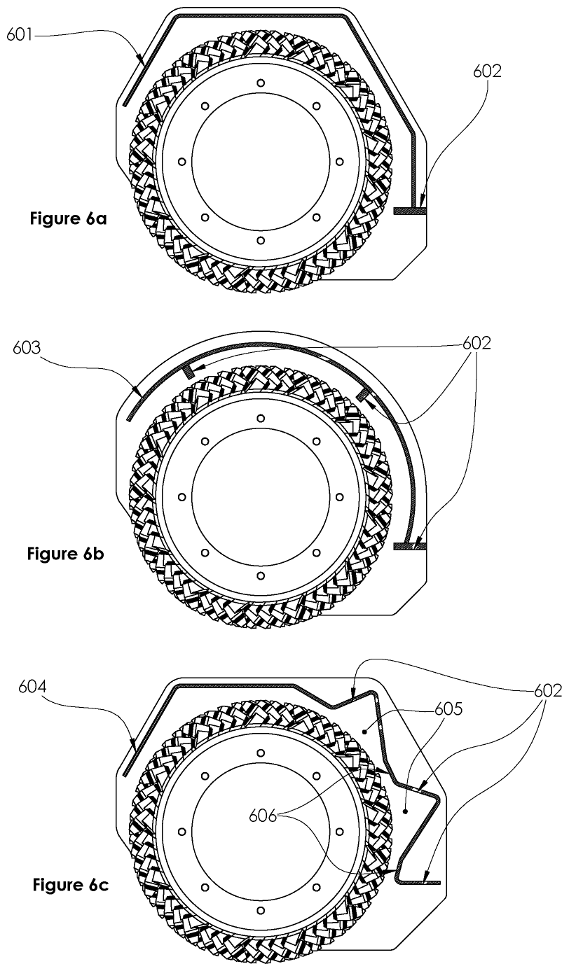

One of the functions of housing shell 202 is to contain and direct the material stream during the material processing, and it can be a variety of shapes. Containing and directing the material stream refers to ushering the material from the entrance of the material processing unit to the exit of the material processing unit and is distinctly different from the actual processing of the material. All housing shell arrangements shown generally direct the discharge stream downward, and although not a practical arrangement, the housing shell could direct the discharge stream horizontally or even vertically. Another common function of the housing shell is to interact with processing targets, which can be placed within the housing shell or integrated into the housing shell. The processing target is a feature, most commonly a surface, that material is trapped against for strike processing or directed at for impact processing. A processing target is placed in the material stream and disrupts the material stream. Referring now to FIG. 6 illustrates several exemplary housing shells with a variety of processing targets. In FIG. 6a, housing shell 601 is an angular profile shown with a single processing target 602 at the entrance of the housing shell to illustrate the containing and directing function of a housing shell. As shown in FIG. 6b, housing shell 603 is a generally circular profile and contains processing targets 602 at the entrance and two other locations within the housing shell.

Referring now to FIG. 6c, housing shell 604 illustrates a housing shell with integrated processing targets 602, and functions as directing, containing and processing the material. Housing shell 604 also illustrates the concept of processing chamber 605, where the material stream is allowed to locally diverge from the general entrance to exit flow of the material processing unit. A processing chamber is distinctly different from a processing target in that the processing target is placed within the general entrance to exit material stream while the processing chamber allows the material stream to diverge from the general entrance to exit material stream. It is not required, but multiple material processing chambers can be separated by a section of the housing shell as shown at locations 606.

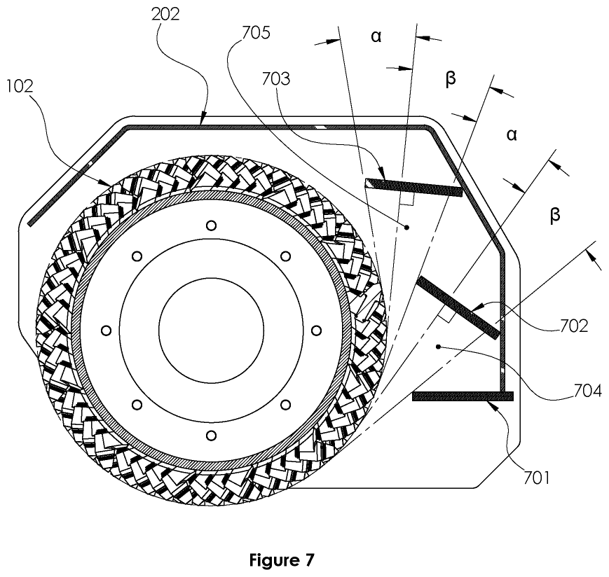

Referring now to FIG. 7 illustrates an example material processing unit with primary target 701 shown in position to function primarily as a strike processor, secondary target 702 is placed in an orientation to act as an impact processor, and tertiary target 703 is shown oriented as an impact processor. The layout shown is an embodiment optimized for multistage impact processing. Once the material passes the primary target and enters the housing it can move away from the rotor core tangentially into processing chamber 704. The larger material will exit the rotor core before the smaller material because it has more mass if consistent material density is assumed. Placement of the secondary and tertiary targets as depicted utilize gravity to re-entrain the material in the processing stream until it is small enough to remain engaged in the rotor assembly and pass one or more targets. A similar processing event will occur as the material passes processing target 702, enters processing chamber 705 and impacts processing target 703. Although not shown, cap plates can be placed to assist in the gravity re-entrainment and prevent buildup of material in the nooks and valleys created by housing shell 202 and processing targets 701, 702 and 703. Placement of the targets and processing chambers as well as the size of the processing chamber can be manipulated to influence the final sizing of the material. Additional processing stages can be added at other locations within the housing assembly and do not require the formal processing chamber. Another aspect of the arrangement depicted in FIG. 7 provides the majority of the weight biased toward the attachment point for the carrier of the processing unit, which improves the handling and manipulation characteristics of the combined material processing and carrier units.

Due to the complexity of an impact event, an idealized set of conditions is assumed to explain the processing event. First, it is assumed that the material being processed is a small spherical particle that does not break during the impact event. Additionally, it is assumed that no energy is absorbed by the target during the impact event. A perfect impact event is defined as an event where the resulting energy vector of the material particle, post-event, is of the same magnitude and opposite direction of the original, pre-event, energy vector. α and β are the unobstructed ranges of the particle's angle of incidence such that the component of the post-event resultant energy vector not opposing the original vector is 15% or less of the original vector's magnitude. α and β are shown in FIG. 7 with respect to a planar target. α and β do not need to be the same value at each processing chamber.

Material processing units typically operate most effectively and efficiently when the direction of rotation has the cutting tool tip engaging the material in the same direction as the direction of travel. Equipment intended to heavily engage material is typically pulled through the material as it places the attachment point in tension, where equipment pushed through the material places the attachment point in compression. One skilled in the art will understand that the condition in which tension is maintained is preferable as it is mechanically more stable. Consequently, many material processing units are mounted at the rear of a carrier unit and pulled through the cutting area. This arrangement requires the carrier unit to travel over unprocessed material which can lead to difficulty maintaining a consistent grade and results in accelerated wear of the tires or tracks of the carrier unit. There are many commercially available carrier units that can carry a material processing unit at the front of the carrier unit, which would allow the carrier unit to operate on processed material offering the operator a clear view of travel and not expose the carrier unit tires or tracks to the additional wear of travelling over unprocessed material. However, if holding to industry conventions these forward processing units will have the rotor counter rotating and frequently push back into the carrier unit, thereby putting the attachment point and supporting structure in compression having less stability. Thus, such material processing units struggle with heavy engagement. Additionally, because these units have the cutting tool tip rotating forward where the material is engaged, they often throw material in front of the unit and typically have a reduced throat such that the material to be processed is captured within the housing before being processed. This limits the size of material that can be engaged by the material processing unit.

Alternate material processing units are known that are constructed in a back drag configuration where the material processing unit is mounted on the front of the carrier unit and is intended to be extended over the material to be processed, lowered into the material and pulled back through the material. These units are typically good at heavy cuts but require the unit to be primarily operated in reverse, which has an obstructed view for the operator and makes it more difficult to maintain a straight line of travel. Additionally, they require many small forward and reverse movements to cover the material being processed which significantly reduces the overall operation efficiency. If the operator chooses to make longer passes the tires or tracks of the carrier unit are exposed to the accelerated wear associated with travelling over the unprocessed material. It is possible to operate these back drag units in a forward processing manner, but they experience a reduced effectiveness and efficiency when operated forward because the material typically escapes the material processing unit before entering the housing to be processed.

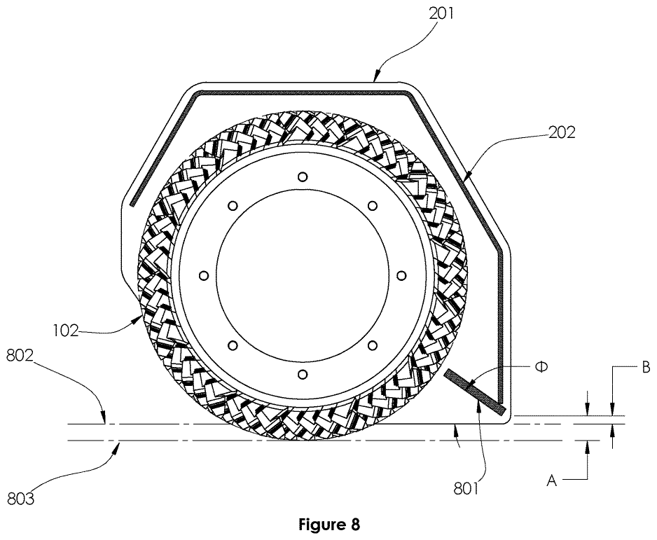

The inventors have developed a bidirectional material processing unit which combines the advantages of a forward processing unit with the ability to heavily engage the material typically associated with a back drag processing unit. As can be seen in FIG. 8, bidirectional member 801 placed with housing shell 202, housing end plate 201 and rotor assembly 102. The location of bidirectional member 801 is shown relative to ground plane 802 by angle φ and distance B. As shown, the lower edge of housing end plate 201 is shown coincident with ground plane 802. Controlling distance B controls the size of the material that can exit the housing before being processed. Various operational characteristics can be achieved by altering φ, and the preferred range of angles is from 0 degrees to 120 degrees. If the only desired characteristic is controlling the size of the material allowed to exit before being processed, than an angle of 0 degrees is acceptable. However, if it is desirable for the bidirectional member to also function as a processing target an angle of 45 degrees is more preferable. Additionally, an angle around 45 degrees also allows the bidirectional member to function as a grader blade and smooth material while also creating a deposit of material to load the rotor assembly. An angle in excess of 90 degrees can allow the bidirectional member to act as a scraper shaping the material. Cut plane 803 is shown to clarify the location of ground plane 802 and extends distance A from the ground plane. Bidirectional member 801 is shown as an independent member but can be integrated into housing shell 202.

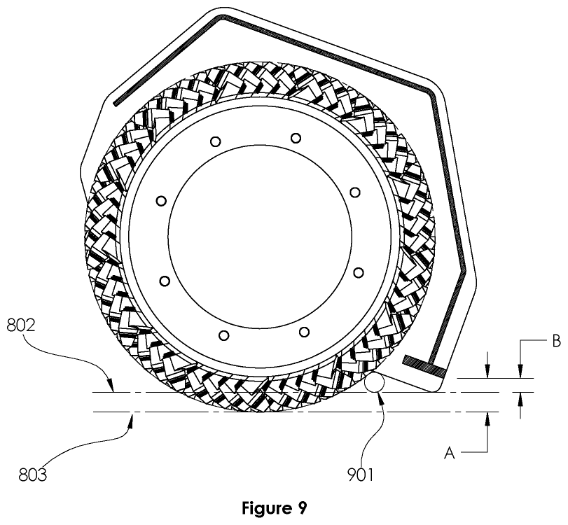

FIG. 8 shows the material processing unit in a level operating orientation; however, the material processing unit can be rolled back as shown in FIG. 9. The rolling manipulation of the material processing unit allows the operator to vary both the distance B and the angle φ. All dimensions given are relative to any operational position of the material processing unit. A key aspect of the bidirectional member is that it is located such that the material is contained within the material processing unit. Rolling the head forward or backward will typically create an open area allowing material to exit from the side of the material processing unit as shown in FIG. 9. For the purpose of describing the allowable open area circular area 901 is shown. Circular area 901 represents the idealized material size that can escape the material processing unit before being processed. In many cases this should be less than 2 inches in diameter. The inventors have found that the best performance is achieved when the distance B is between 0 and 3 inches.

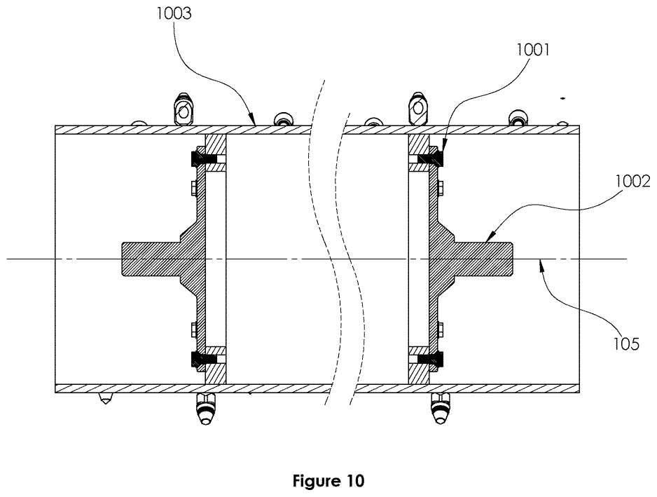

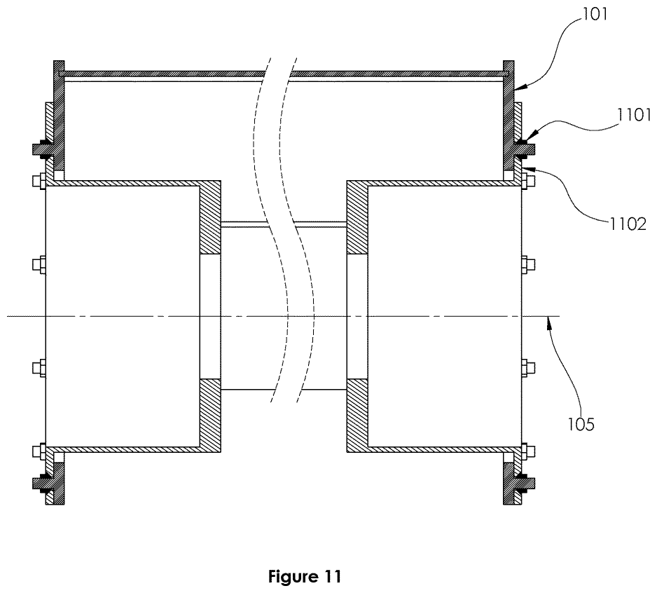

Two other component interactions that affect the placement and alignment of the rotational axis are the locations where the support shafts interact with the rotor core and where the rotor mounts interact with the housing assembly. These connections are typically a bolted connection and are either piloted about the center or centered using a series of conventional straight shank bolts. Maintaining proper alignment requires tight pilot bores and bosses which are difficult to insert and remove, especially when dirty from use. When a pilot arrangement is not used and the series of bolts are used the alignment is limited to the tolerance and spacing of the bolts and associated holes, and if the components are indicated into alignment, friction between the parts is the only thing maintaining the alignment. These concepts are commonly referred to as a hub-centric design. Due to the limitations and problems associated with the hub-centric approach the inventors have developed a lug-centric arrangement where tapers are integrated on the mounting hardware and associated components. Referring now to FIG. 10, an embodiment of a centering bolt 1001 and support shaft 1002 are shown in the cross-section view. An embodiment of a centering nut 1101 and rotor mount 1102 are shown in the cross-section view of FIG. 11. These fastening features utilize a large contoured surface when seated to provide component alignment. The surfaces are shown as straight tapered, but can be round, parabolic or other profile which promotes alignment. The lug-centric approach offers superior alignment between the components as it allows for large piloting clearances or no pilot features at all, as well as facilitating large clearances between the pin portion of the fastener and the through mounted component while not compromising the final alignment. The centering hardware is shown in an exemplary way in the figures but can be used interchangeably as nuts and bolts for the various implementation of centering hardware described.

Material processing units are typically driven by a hydraulic system, which can be an auxiliary circuit on the carrier unit or a dedicated power pack. The operator engages the material processing unit into the material and monitors the operating pressure of the material processing unit. The more the unit is engaged in the material the higher the operating pressure rises until a stall pressure is attained where the resistance in the material is larger than the power that can be supplied or the relief pressure of the supply circuit is reached. When this condition is reached the rotor will stall. If the displacement of the motor is constant, the rotational speed of the rotor will decrease as the load is increased. The stalling of the rotor is often a sudden event and a step change in operating pressure as the power required by material processing exceeds the power supplied to the material processing unit. Although many attempts are made to provide the user with detailed numeric or visual feedback, the operator often operates based on feel and sound. The carrier units are typically large in comparison to the material processing head and able to apply significant tractive force engaging the material processing unit in the cut with ease, which limits the feel and sound feedback to the operator. This leads to the operator running the unit substantially below the stalling threshold or repeatedly stalling the unit while riding the stalling threshold condition. Running substantially below the stalling threshold leads to a longer time to complete the job. Repeatedly stalling can also increase the time to complete a job because of the wasted movements to remediate the stall event, and cause inconsistencies in the cut surface from the start-stop event.

A variable displacement motor coupled with an electronic control system offers the ability to adjust the motor displacement and thereby change the specific torque (torque per pressure applied) of the motor in response to varying loading of the material process unit. A variety of parameters such as operating pressure, rotational speed and motor displacement can be monitored and/or manipulated to prevent a stall event. An example algorithm would use a pressure threshold that when exceeded would increase the motor displacement thereby increasing the torque applied. Another example algorithm would monitor the rotational speed and adjust the motor displacement up or down to match a target rotational speed. Another example algorithm would monitor both the operating pressure and rotational speed adjusting the motor displacement to attain a desired combination of rotational speed and applied pressure.

The most efficient and effective operating parameters will vary based on the material being processed and the level of processing desired. Significant benefits in operational efficiency and a reduction in equipment wear can be obtained by allowing the operator to select a predefined set of operating parameters and an appropriate algorithm that is optimized for each of the various operating conditions. This set of parameters and algorithm can be considered a tune. Equipping a material processing unit with a control system containing multiple tunes accessible to the operator would facilitate improved operations with less experienced operators and allow more experienced operators the ability to further tailor the operation of the material processing unit.

Another feature that can be integrated with the control system is Over The Air (OTA) functionality where the tunes, operating parameters or overall controller program can be updated OTA with or without user intervention. Additionally, a data logging feature can record operating parameters that can be transmitted back or discretely retrieved for analysis and incorporation into the database for creating the tunes. Furthermore, the OTA system can be used for remote support and diagnostics by allowing remote viewing in real-time of the material processing unit operating conditions. A more in-depth implementation would allow remote interaction of the system where parameters can be adjusted real-time remotely.

Many embodiments that have been disclosed revolve around mitigating imbalance in the material processing unit because of the detrimental impacts associated with the loading resulting from the imbalance. The control system can be constructed to include an onboard balancing system that can be used to monitor balance of the material processing unit. One manner of accomplishing this is to monitor the acceleration of the material processing unit and record the acceleration correlated with the angular position of the rotor. The acceleration can be measured in one or more planes. A common method of measuring the acceleration is to use an accelerometer which can be configured in single or multi-axis embodiments. One embodiment could have the accelerometer or accelerometers removably attached to the material processing unit, where they are placed during the balancing operation and removed during normal operations. Another embodiment could have the accelerometer or accelerometers mounted to the material processing unit and remain in place during normal operations.

In the event that the accelerometer or accelerometers remain in place during normal operations the acceleration of the material processing unit can be monitored during operations providing feedback on the condition of the cut and condition of the material processing unit. Additionally, the acceleration information can be utilized within the control algorithm to adjust the operating parameters. One aspect of the acceleration monitoring could be used to identify if a cutting tool or cutting tool holder has come off of the rotor without having to visually inspect the rotor, which would present as a sudden change in the acceleration signature. One manner of implementing this monitoring would be to have a baseline acceleration signature that is compared to the current acceleration signature when the operating pressure is at a minimum which would indicate that the rotor is not engaged in a cut. Another aspect of the acceleration monitoring would be to analyze how smooth the material processing unit is running while in a cut, and if the acceleration signature indicates a rough operating environment the operating parameters can be adjusted automatically or feedback given to the operator to adjust the manner in which the material processing unit is being operated.

The foregoing describes exemplary embodiments of a material processing unit, components and features. Such configurations may be used in a variety of applications. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

We claim:

1. A material processing unit, comprising:
a housing;
a motor;
a target;
a rotor assembly rotated by the motor and having features for placement of material engaging cutting tools;
wherein the housing comprises a housing shell having two ends; and
an end plate having at least one inset pocket to accept a housing component.

2. The material processing unit of claim 1, wherein one or more inset pockets are configured to be slidably engaged by a housing component.

3. The material processing unit of claim 1, wherein the target is oriented at an angle between 30 degrees and 60 degrees of a horizontal plane.

4. The material processing unit of claim 1, further comprising a processing chamber having at least 80% of the tangents to the rotor assembly that enter the processing chamber intersect the target with at least 85% of a tangent vector normal to the target.

5. The material processing unit of claim 1, further comprising a secondary target, wherein the target and the housing shell form a first processing chamber such that at least 80% of the tangents to the rotor assembly entering the first processing chamber intersect the secondary target with at least 85% of a tangent vector normal to the secondary target.

6. The material processing unit of claim 1, further comprising a second end plate having an inset pocket to accept a second housing shell end.

7. The material processing unit of claim 1, further comprising a second end plate having a second slidably engageable pocket to receive and retain a housing component.

8. The material processing unit of claim 1, further comprising a skeletonized overlay plate affixed to and reinforcing the housing shell and covering less than 50% of the housing shell at a location adjacent material impacts radial to the rotor assembly.

9. A housing for a material processing unit, comprising:
a target;
a housing shell having two ends;
an end plate secured to one of the housing shell ends;
wherein the housing is adapted to connect to a rotor assembly rotated by a motor and having material cutting tools; and
wherein the end plate is connected to the target between 0 inches and 3 inches above a ground plane.

10. The housing of claim 9, wherein one or more inset pockets are configured to be slidably engaged by a housing component.

11. The housing of claim 9, wherein the target is oriented within 15 degrees of normal to a tangent of the rotor assembly that intersects the target.

12. The housing of claim 9, further comprising a processing chamber having at least 80% of the tangents to the rotor assembly that enter the processing chamber intersect the target with at least 85% of a tangent vector normal to the target.

13. The housing of claim 9, further comprising a secondary target, wherein the target and the housing shell form a first processing chamber such that at least 80% of the tangents to the rotor assembly entering the first processing chamber intersect the secondary target with at least 85% of a tangent vector normal to the secondary target.

14. The housing of claim 9, further comprising a second end plate having an inset pocket to accept a second housing shell end.

15. The housing of claim 9, further comprising a second end plate having a second slidably engageable pocket to receive and retain a housing component.

16. The housing of claim 9, further comprising a skeletonized overlay plate affixed to and reinforcing the housing shell and covering less than 50% of the housing shell at a location adjacent to material impacts radial to the rotor assembly.

17. A material processing unit, comprising:
a housing;
a motor;
a target;
a rotor assembly rotated by the motor and having features for placement of material engaging cutting tools;
wherein the housing comprises a housing shell having two ends;
an end plate having an inset pocket to accept one of the housing shell ends;
a rotor mount attachable to the end plate and the rotor, having centering lugs to attach the rotor mount to the end plate;
wherein the end plate further comprises an inset groove to receive and retain the target; and
wherein the target is between 0 inches and 3 inches above a ground plane.

18. The material processing unit of claim 17, wherein the target is oriented at an angle of 45 degrees, plus or minus 15 degrees, of a horizontal plane.

19. The material processing unit of claim 17, further comprising a processing chamber having at least 80% of the tangents to the rotor assembly that enter the processing chamber intersect the target with at least 85% of a tangent vector normal to the target.

20. The material processing unit of claim 17, further comprising a secondary target, wherein the target and the housing shell form a first processing chamber such that at least 80% of the tangents to the rotor assembly entering the first processing chamber intersect the secondary target with at least 85% of a tangent vector normal to the secondary target.

21. The material processing unit of claim 17, further comprising a second end plate having a inset pocket to accept a housing component.

22. The material processing unit of claim 17, further comprising a second end plate having a second inset groove to receive and retain a housing component.

23. A material processing unit, comprising:
a housing comprising:
a housing shell;
an end plate attached to the housing shell;
a motor;
a rotor assembly adapted to be rotated by the motor and having features for placement of material engaging cutting tools; and
a rotor centering mechanism comprising:
a centering plate having a shaft attachable to the rotor and centering lug holes; and
centering lugs adapted to fit the lug holes.

24. The material processing unit of claim 23, wherein the end plate is adapted to receive a target.

25. A material processing unit, comprising:
a housing;
a motor;
a target;
a rotor assembly rotated by the motor and having features for placement of material engaging cutting tools;
wherein the housing comprises a housing shell having two ends;
an end plate having an inset pocket to accept one of the housing shell ends; and
wherein the end plate further comprises an inset pocket to receive and retain the target between 0 and 3 inches above a ground plane.

26. The material processing unit of claim 25, having a second inset pocket that receives and retains a housing component.

27. A material processing unit, comprising:
a housing;
a motor;
a target;
a rotor assembly rotated by the motor and having features for placement of material engaging cutting tools; and
a processing chamber having at least 80% of the tangents to the rotor assembly that enter the processing chamber intersect the target with at least 85% of a tangent vector normal to the target.

28. The material processing unit of claim 27, further comprising a secondary target, wherein the target and the housing shell form a first processing chamber such that at least 80% of the tangents to the rotor assembly entering the first processing chamber intersect the secondary target with at least 85% of a tangent vector normal to the secondary target.
